(19) United States
(12) Patent Application Publication
(10) Pub. No.: US 2008/0161058 A1
(43) Pub. Date: Jul. 3, 2008

(54) Method and Mobile Communication Terminal for Providing Function of Hyperlink Telephone Number Including Short Message Service

(75) Inventors: Youngmin Park, Seoul (KR); Chaeyong Yi, Seoul (KR); Hoojong Kim, Seoul (KR)

Correspondence Address: LOWE HAUPTMAN HAM & BERNER, LLP, 1700 DIAGONAL ROAD, SUITE 300, ALEXANDRIA, VA, 22314, US

(73) Assignee: SK TELECOM CO., LTD., Seoul (KR)

(21) Appl. No.: 11/911,303

(22) PCT Filed: Jun. 5, 2006
(86) PCT No.: PCT/KR2006/002298

§ 371 Date: Oct. 11, 2007

(30) Foreign Application Priority Data
Jun. 15, 2005 (KR) 10-2005-0051590

(51) Int. Cl. H04M 1/00

(52) U.S. Cl. 455/564

(57) ABSTRACT

Disclosed are a mobile communication terminal and a method for detecting and extracting a phone number included in an SMS message and activating a hyperlink function on the extracted phone number to initiate an outgoing call to the phone number or store it in a phonebook of the mobile communication terminal. The method includes the steps of: (a) receiving and outputting a text message, and determining whether a phone number is included in the received text message; (b) determining whether a selection bar is placed on a phone number included in the received text message; (c) determining whether a call key input signal or a phonebook key input signal is received, if the selection bar is placed on the phone number; and (d) dialing or storing the phone number, if the call key input signal or the phonebook key input signal is received.

### TECHNICAL FIELD

The present invention relates to a mobile communication terminal and method for activating a hyperlink function on a phone number included in an SMS message, and more particularly to a mobile communication terminal and method for detecting and extracting a phone number included in an SMS message and activating a hyperlink function on the extracted phone number to initiate an outgoing call to the phone number or store it in the phonebook of the mobile communication terminal.

### BACKGROUND ART

With the development of mobile and wireless technologies, mobile communication terminals, such as cell phones and PCS phones, have been widely supplied and developed to become smaller, sleeker and lighter and to offer various additional functions and services.

In addition to the standard voice function of a telephone, mobile communication terminals can support many additional communication services, such as SMS (Short Message Service) for text messaging and voice message transmission (i.e. voice mail) service for storing speech and transmitting stored speech data upon a user's request.

The population using a wireless Internet service and a location tracking service for obtaining the current location information of a mobile communication terminal has also rapidly grown in recent years.

As the most popular function used in mobile terminals, SMS offers a bi-directional data service that allows users to send or receive text messages of up to 150 characters in length. SMS messages are sent and received almost simultaneously without the use of any additional operator. Since SMS enables convenient visual communication between users, SMS usage continues to grow among people of varying ages, including young children and even elderly people who are not accustomed to obtaining new information.

SMS has been used as a new form of communication alternative to the typical voice communication. Due to its lower transmission cost, SMS is now viewed as a crucial tool for the support of customer service and marketing. SMS is also commonly used to provide subscribed mobile users with useful information such as weather forecasts, news or stock quotes. Users can search various information offered via SMS. SMS is becoming available for a wider range of applications including e-payment and e-commerce. For example, most credit card companies have introduced an SMS service system to inform customers of their credit card transactions.

Generally, an SMS text message is inputted using an application program, i.e. an SMS editor, provided in a mobile communication terminal. When a user selects an SMS menu on a mobile terminal, the SMS editor displays a main window for inputting an SMS message under the control of a control unit. Subsequently, when the user selects a “Korean” menu in the main window using soft keys, the SMS editor then displays sub-menus for selecting Korean letters, digits, uppercase letters, lowercase letters and special characters or symbols.

The user can input an SMS message, including text and a phone number or an email address of the user (sender), using the sub-menus.

When a recipient who receives the SMS message makes a call to the message sender, he or she has to memorize or make a note of the sender's phone number and terminate the SMS application program. Then the recipient can make a call to the memorized or noted phone number directly or after storing the phone number in the phonebook.

### DISCLOSURE OF THE INVENTION

Therefore, the present invention has been made in view of the above-mentioned problems, and it is an object of the present invention to provide a mobile communication terminal and method for detecting and extracting a phone number included in an SMS message and activating a hyperlink function on the extracted phone number to initiate an outgoing call to the phone number or store it in the phonebook of the mobile communication terminal.

According to an aspect of the present invention, there is provided a method for creating a hyperlink function on a phone number included in a text message in a mobile communication terminal, the method comprising the steps of: (a) receiving and outputting a text message, and determining whether a phone number is included in the received text message; (b) determining whether a selection bar is placed on a phone number included in the received text message; (c) determining whether a call key input signal or a phonebook key input signal is received, if the selection bar is placed on the phone number; and (d) dialing or storing the phone number, if the call key input signal or the phonebook key input signal is received.

In accordance with another aspect of the present invention, there is provided a method for creating a hyperlink function on a phone number included in a text message in a mobile communication terminal, the method comprising the steps of: (a) receiving and outputting a text message, and determining whether a phone number is included in the received text message; (b) determining whether a selection bar is placed on a phone number included in the received text message; (c) determining whether a menu key input signal is received, if the selection bar is placed on the phone number; (d) displaying a menu containing one or more function modes of the mobile communication terminal, if the menu key input signal is received; and (e) implementing a selected function mode if a corresponding function mode selection signal is received.

In accordance with another aspect of the present invention, there is provided a mobile communication terminal capable of creating a hyperlink function on a phone number included in a text message, the mobile communication terminal comprises: a key input unit provided with a plurality of alphanumeric keys, a call key, an end key and function keys for dialing, selecting a menu or inputting a request, enabling a user to move and place a selection bar on a phone number included in a received text message, generating a phone number selection signal when the user selects the phone number with the selection bar placed thereon, and generating a menu selection signal when the user selects either a call menu or a phonebook storage menu provided at the lower part of the display of the text message; a display unit for displaying the operational status of the mobile communication terminal, including radio signal strength, battery charge level and current date/time, and providing a user interface display including the phone number hyperlinked in the received text message and the call menu and phonebook storage menu linked to the text message; a memory having a phone number processing program for detecting a sequence of consecutive digits included in the received text message, determining whether the sequence of consecutive digits is a phone number, detecting when the user places the selection bar on the phone number and presses a call key or a phonebook key provided on the key input unit, dialing the phone number when a call key input signal is received, and storing the phone number when a phonebook key input signal is received; and a microprocessor for controlling the mobile communication terminal to process data transmission or reception according to a defined communication protocol, and implementing the phone number processing program stored in the memory so as to perform a function to dial or store the phone number included in the text message.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing the configuration of a mobile communication terminal capable of activating a hyperlink function on a phone number included in a text message according to a preferred embodiment of the present invention;

FIG. 2 is a flowchart showing a process of activating a hyperlink function on a phone number included in a text message according to a preferred embodiment of the present invention; and

FIG. 3 illustrates user interface displays providing a hyperlink on a phone number included in a text message and including a call menu and a phonebook menu for making a call to or storing the phone number according to a preferred embodiment of the present invention.

### BEST MODE FOR CARRYING OUT THE INVENTION

Hereinafter, preferred embodiments of the present invention will be described with reference to the accompanying drawings. In the following description of the present invention, a detailed description of known functions and configurations incorporated herein will be omitted when it may make the subject matter of the present invention unclear.

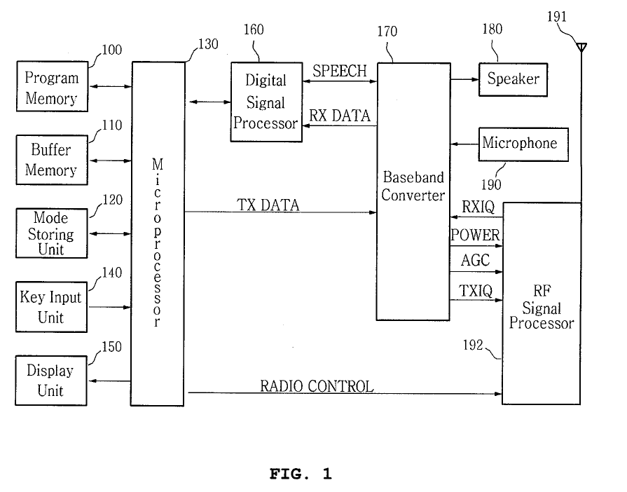

FIG. 1 is a block diagram showing the configuration of a mobile communication terminal capable of activating a hyperlink function on a phone number included in a text message according to a preferred embodiment of the present invention.

Referring to FIG. 1, the mobile communication terminal includes a program memory 100, a buffer memory 110, a mode storing unit 120, a microprocessor 130, a key input unit 140, a display unit 150, a digital signal processor 160, a baseband converter 170, a speaker 180, a microphone 190, an antenna 191 and an RF signal processor 192.

The program memory 100 stores OS (Operating System) software for real-time processing during the operation of the mobile terminal and a signal processing software for implementing signal-processing related functions. According to a preferred embodiment of the present invention, the program memory 100 also stores a phone number processing program for detecting a consecutive sequence of digits included in a received text message, determining whether the consecutive sequence of digits is a phone number, and implementing a function to call or store the consecutive sequence of digits as a phone number according to the user's selection of a key (a call key or a phonebook key).

When the mobile communication terminal receives a text message through a text message interface, the phone number processing program determines whether a consecutive sequence of digits included in the received message is a phone number, using a phone number detecting algorithm, and automatically generates a hyperlink on the consecutive sequence of digits, i.e. the phone number in blue color.

Also, when the received message includes a phone number, the phone number processing program creates a call menu and a phonebook storage menu at the lower part of the display screen while displaying the received message, and implements a function to dial or store the phone number included in the received message according to the selection of a linked menu (the call menu or the phonebook storage menu).

The user can place a selection bar on the hyperlinked phone number using alphanumeric keys, function keys or direction keys provided on the key input unit 140 and then select the call key or the phonebook key. When a call key input signal is generated, the phone number processing program is implemented to dial the phone number on which the selection bar is placed. When a phonebook key input signal is generated, the phone number processing program is implemented to store the phone number on which the selection bar is placed in the phonebook of the mobile terminal.

The phone number detecting algorithm is used to determine whether a consecutive sequence included in a text message is a sequence of consecutive digits, Korean letters or English letters. When consecutive digits are detected, the phone number detecting algorithm sequentially checks the consecutive digits one by one to extract any delimiter, such as a hyphen -, dot . or slash /, included in the consecutive digits. When the use of a delimiter is detected, the phone number detecting algorithm confirms whether the digits are seven or more excluding the delimiter. If so, the phone number detecting algorithm will determine that the consecutive digits (for example, “011.123.1234,” “011/123/1234,” “0111231234” or “1231234”) constitute a phone number.

If a consecutive sequence includes parentheses or letters other than digits, the phone number detecting algorithm will determine that the sequence does not represent a phone number.

Through the above process, a phone number included in a text message can be detected and extracted. Of course, the phone number detecting algorithm is not limited to that explained above. Various algorithms can be utilized to rapidly detect a phone number in a received text message.

The phone number processing program can be embedded in the program memory 100 during the manufacture of a mobile terminal or downloaded from a mobile communication service provider's server through a wireless Internet access.

The buffer memory 110 may use any one of a ROM, an EEPROM, a RAM, a flash memory or a volatile or nonvolatile memory. The buffer memory 110 is mounted on an internal circuit board of the mobile terminal. Generally, a ROM stores an operating program and a system program of the microprocessor 130. The ROM can be electrically erased and reprogrammed repeatedly if necessary. Also, the ROM stores program variables and status information generated in the execution of various programs stored in the program memory 100, such as the phone number processing program embedded in the memory 100.

An EEPROM is an electrically erasable and programmable nonvolatile memory that stores storage data, such as NAM (Number Assignment Module) parameters, phone numbers, names and short messages.

The buffer memory 110 generally serves as a data buffer during the implementation of an operating program of the mobile terminal. The buffer memory 110 temporarily stores data inputted through the key input unit 140. Also, the buffer memory 110 stores text or image data received from an external device. When a user selects a phone number included in a received text message and a linked menu, such as a call menu or a phonebook storage menu, using the key input unit 140, the buffer memory 110 stores information on the selected number and the linked menu.

The mode storing unit 120 stores the current operating mode of the mobile terminal as selected through the key input unit 140 using a state flag (0, 1, 2, . . . ). The microprocessor 130 assigns a unique state flag to each mode in order to identify different modes of the mobile terminal, such as reception mode, transmission mode, storage mode, search mode, call mode and text message integrated management mode, and updates the mode storing unit 120. Particularly, the mode storing unit 120 stores the phone number processing mode using a state flag according to a preferred embodiment of the present invention.

The microprocessor 130 controls the overall operation of the mobile terminal so that a communication protocol can be processed according to the defined protocol for network and data, referring to the state flags stored in the mode storing unit 120. Particularly, the microprocessor 130 controls the mobile terminal to display a text message received through a text message interface on the display unit 150. The microprocessor 130 determines whether a sequence of consecutive digits corresponding to a phone number is included in the received message. If such a sequence of consecutive digits is included in the received message, the microprocessor 130 will generate a hyperlink on the consecutive digits in blue.

The user can place a selection bar on the hyperlinked phone number using keys provided on the key input unit 140 and then select the call key or the phonebook key. If a call key input signal is received, the microprocessor 130 will dial the phone number selected with the selection bar. If a phonebook key input signal is received, the microprocessor 130 will store the phone number selected with the selection bar in the phonebook of the mobile terminal.

If the user presses a menu key while placing the selection bar on the hyperlinked phone number, the microprocessor 130 will display various function modes, such as “save,” “call” and “message sending.” When the user selects one of the function modes, the microprocessor 130 then implements the selected function mode (call, save or send a message).

If a received text message includes two or more hyperlinked phone numbers and the user presses a select key while placing the selection bar on one of the hyperlinked phone numbers, the microprocessor 130 will display a text message received from the selected phone number and create a call menu and a phonebook storage menu at the lower part of the displayed message.

When the user selects the call menu or the phonebook storage menu, the microprocessor 130 implements a corresponding function. More specifically, when a call menu selection signal is received, the microprocessor 130 dials the hyperlinked phone number in the text message. When a phonebook menu selection signal is received, the microprocessor 130 stores the hyperlinked phone number in the phonebook of the mobile terminal.

The key input unit 140 is provided with a plurality of alphanumeric keys, a call key, an end key and other function keys for dialing, selecting a menu or inputting a request. If a received text message includes two or more phone numbers, the user can select one of the phone numbers by placing the selection bar thereon. In such a case, the key input unit 140 generates a corresponding phone number selection signal and transmits the signal to the microprocessor 130. When the user selects either the call menu or the phonebook storage menu provided at the lower part of the displayed text message, the key input unit 140 generates a corresponding menu selection signal and transmits the signal to the microprocessor 130.

The display unit 150 displays the operational status of the mobile terminal, including radio signal strength, battery charge level, current date and time of day. According to a preferred embodiment of the present invention, the display unit 150 displays a received text message, a hyperlinked phone number included in the received message and linkable menus, such as a call menu and a phonebook storage menu.

The digital signal processor (“DSP”) 160 implements an audio data processing function that encodes or decodes audio data received from or transmitted to the baseband converter 170. The DSP 160 also implements an equalizer function for removing noise in multiple paths. In addition, the DSP 160 receives message data (RX DATA) from the baseband converter 170.

The baseband converter 170 converts signals received from or sent to the speaker 180, microphone 190 or RF signal processor 192 into baseband signals. The baseband converter 170 performs both analog-to-digital conversion and digital-to-analog conversion. The baseband converter 170 converts audio data received from the DSP 160 into an audio signal and outputs the audio signal to the speaker 180. Also, the baseband converter 170 converts an audio signal inputted from the microphone 190 into audio data and outputs the audio data to the DSP 160.

In addition, the baseband converter 170 converts transmitted message data (TX DATA) inputted from the microprocessor 130 into a transmitted message signal (TXIQ) and outputs the signal to the RF signal processor 192. It also converts a received message signal (RXIQ) inputted from the RF signal processor 192 into received message data (RX DATA) which will be outputted to the DSP 160. The baseband converter 170 automatically controls gain of the power of the RF signal processor 192.

The speaker 180 converts an audio signal outputted from the baseband converter 170 into audible sound and outputs the sound. Also, it converts speech inputted through the microphone 190 into an audio signal.

The antenna 191 transmits an RF signal over the air, and transfers an RF signal received over the air to the RF signal processor 192.

The RF signal processor 192 converts a received message signal into an RF (Radio Frequency) signal and outputs the signal to the antenna 191. Also, the RF signal processor 192 converts an RF signal applied from the antenna 191 into a received message signal (RXIQ) and outputs the signal to the baseband converter 170.

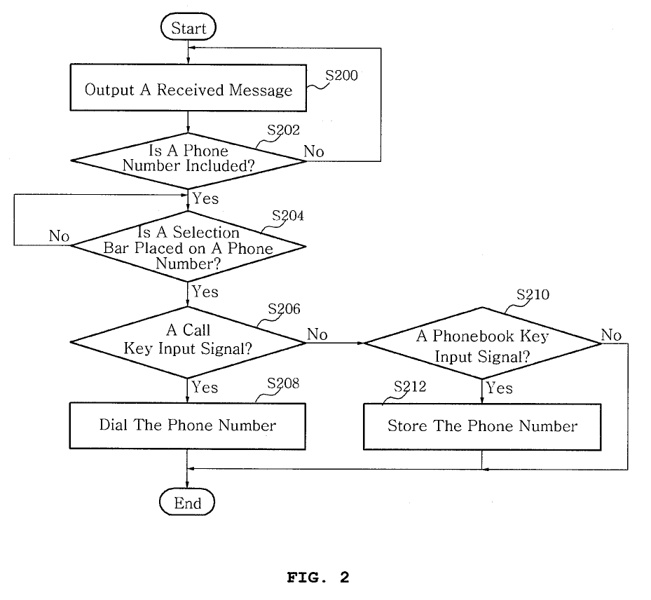

FIG. 2 is a flowchart showing a process of activating a hyperlink function on a phone number included in a text message according to a preferred embodiment of the present invention.

It is assumed that a phone number processing program is embedded in a mobile communication terminal and that any phone number included in a received text message is hyperlinked in blue.

When a text message is transmitted from a short message service center (SMSC) which communicates with a mobile communication network and received through a text message interface, the mobile communication terminal outputs the received message to the display unit 150 (S200). At the same time, the microprocessor 130 implements the phone number processing program to determine whether a phone number is included in the received message using a phone number detecting algorithm (S202). If a sequence of consecutive digits corresponding to a phone number is detected in step S202, the mobile terminal will create a hyperlink on the phone number and will determine whether a selection bar is placed on the hyperlinked phone number (S204). The phone number detecting algorithm is used to determine whether a consecutive sequence included in a text message is a sequence of consecutive digits, Korean letters or English letters. When consecutive digits are detected, the phone number detecting algorithm sequentially checks the consecutive digits one by one to extract any delimiter, such as a hyphen -, dot . or slash /, included in the consecutive digits. When the use of a delimiter is detected, the phone number detecting algorithm confirms whether the digits are seven or more excluding the delimiter. If so, the phone number detecting algorithm will determine that the consecutive digits (for example, “011.123.1234,” “011/123/1234,” “0111231234” or “1231234”) constitute a phone number.

If a consecutive sequence includes parentheses or letters other than digits, the phone number detecting algorithm will determine that the sequence does not represent a phone number.

In other words, if it is determined that a consecutive sequence consists of digits only (without any letters or special characters), the consecutive sequence will then be recognized as a phone number. Through the above process, a phone number included in a text message can be detected and extracted. Of course, the phone number detecting algorithm is not limited to that explained above. Various algorithms can be utilized to rapidly detect a phone number in a received text message.

In a case where two or more phone numbers are included and hyperlinked in a text message (for example, “(1) Mobile phone number of Hong Gildong: 011-0003-3445, (2) Mobile phone number of Han Hyerim: 016-3920-3939, . . . ”), the user can select one of the hyperlinked phone numbers by placing the selection bar thereon. Then the user interface screen will be linked to a text message received from the selected phone number and will create the call menu and the phonebook storage menu at the lower part of the display of the message.

If the user presses the call key while placing the selection bar on a hyperlinked phone number, the mobile terminal will dial the hyperlinked phone number. If the user presses the phonebook key while placing the selection bar on a hyperlinked phone number, the mobile terminal will display a phone number registration menu so that the user can input various items, such as the corresponding user's name, phone number, photograph, bell sound and address, using keys and store them in the phonebook.

If it is determined that the selection bar is placed on a hyperlinked phone number (S204), the mobile terminal will then determine whether a call key input signal is received through the key input unit 140 (S206). If the call key input signal is detected, the microprocessor 130 will control the mobile terminal to dial the hyperlinked phone number (S208).

If the microprocessor 130 determines that the call key input signal is not received (S206), it will then determine whether a phonebook key input signal is received through the key input unit 140 (S210). If the phonebook key input signal is detected, the microprocessor 130 will control the mobile terminal to store the hyperlinked phone number in the phonebook (S212).

According to another preferred embodiment of the present invention, the user can press a menu key while placing the selection bar on a hyperlinked phone number in a text message. Then various function modes, such as “save,” “call” and “message sending,” are displayed. If the user selects one of the function modes, the mobile terminal will implement the selected function mode (call, save or send a message).

According to still another embodiment of the present invention, the mobile terminal determines whether the hyperlinked phone number has been previously stored in the phonebook after step S204. If the hyperlinked phone number is present in the phonebook, the phone number storing step (S212) can be skipped.

According to still another embodiment of the present invention, the call menu and the phonebook storage menu can be linked at the lower part of the displayed text message so that the function to dial or store the hyperlinked phone number can be additionally implemented according to a menu selection signal.

According to still another embodiment of the present invention, an additional step is carried out to extract only number (consecutive digits) information from an image photographed using a camera, determine whether the extracted number is a phone number using a phone number detecting algorithm, create a hyperlink on the phone number, and implement a function to dial or store the hyperlinked phone number.

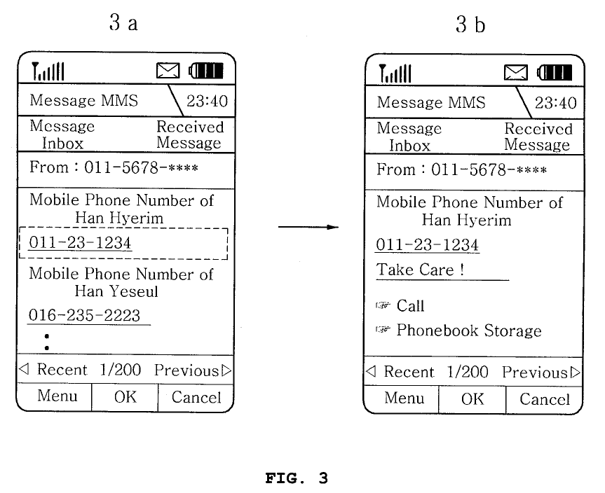

FIG. 3 illustrates user interface displays providing a hyperlink on a phone number included in a text message and including a call menu and a phonebook menu for dialing or storing the phone number according to a preferred embodiment of the present invention.

When a text message is received, the mobile terminal creates a hyperlink on a phone number included in the received message according to the phone number processing program. The user can place the selection bar on the hyperlinked phone number using alphanumeric keys, function keys or cursor moving keys provided on the key input unit 140. If the user presses the call key while placing the selection bar on the hyperlinked phone number, the mobile terminal will dial the selected phone number. If the user presses the phonebook key, the mobile terminal will store the selected phone number in the phonebook.

If the user selects one of multiple phone numbers included in a text message by placing the selection bar thereon as illustrated in FIG. 3a, the user interface screen will be linked to a text message received from the selected phone number and will create the call menu and the phonebook storage menu at the lower part of the display of the message as illustrated in FIG. 3(b).

The user can implement the function to dial or store a hyperlinked phone number by selecting the call menu or the phonebook storage menu using the alphanumeric keys, function keys or cursor moving keys provided on the key input unit 140. Alternatively, the user can implement the function to dial or store the hyperlinked phone number by placing the selection bar on the phone number and then pressing the call key or the phonebook key.

As explained above, the mobile communication terminal and method according to the present invention create a hyperlink on a phone number included in a received message and enable a user to directly dial or store the phone number, without the need to memorize or make a note of the phone number.

Although preferred embodiments of the present invention have been described for illustrative purposes, those skilled in the art will appreciate that various modifications, additions and substitutions are possible, without departing from the scope and spirit of the invention as disclosed in the accompanying claims.

1. A method for creating a hyperlink function on a phone number included in a text message in a mobile communication terminal, the method comprising the steps of:
(a) receiving and outputting a text message, and determining whether a phone number is included in the received text message;
(b) determining whether a selection bar is placed on a phone number included in the received text message;
(c) determining whether a call key input signal or a phonebook key input signal is received, if the selection bar is placed on the phone number; and
(d) dialing or storing the phone number, if the call key input signal or the phonebook key input signal is received.

2. The method according to claim 1, further comprising the steps of:
(e) receiving a phone number selection signal if one of multiple phone numbers included in the received text message is selected; and
(f) generating a call menu and a phonebook storage menu to be linked to the text message, dialing the phone number included in the phone number selection signal when a call menu input signal is received, and storing the phone number in a phonebook when a phonebook menu input signal is received.

3. The method according to claim 1, further comprising the step of: (g) determining whether the phone number with the selection bar placed thereon is present in the phonebook after the step (b); and skipping the step of storing the phone number in the phonebook, if the phone number is present in the phonebook.

4. A method for creating a hyperlink function on a phone number included in a text message in a mobile communication terminal, the method comprising the steps of:
(a) receiving and outputting a text message, and determining whether a phone number is included in the received text message;
(b) determining whether a selection bar is placed on a phone number included in the received text message;
(c) determining whether a menu key input signal is received, if the selection bar is placed on the phone number;
(d) displaying a menu containing one or more function modes of the mobile communication terminal, if the menu key input signal is received; and
(e) implementing a selected function mode if a corresponding function mode selection signal is received.

5. The method according to claim 4, wherein said function modes include save, call and message sending modes.

6. A mobile communication terminal capable of creating a hyperlink function on a phone number included in a text message, the mobile communication terminal comprises:
a key input unit provided with a plurality of alphanumeric keys, a call key, an end key and function keys for dialing, selecting a menu or inputting a request, enabling a user to move and place a selection bar on a phone number included in a received text message, generating a phone number selection signal when the user selects the phone number with the selection bar placed thereon, and generating a menu selection signal when the user selects either a call menu or a phonebook storage menu provided at the lower part of the display of the text message;
a display unit for displaying the operational status of the mobile communication terminal, including radio signal strength, battery charge level and current date/time, and providing a user interface display including the phone number hyperlinked in the received text message and the call menu and phonebook storage menu linked to the text message;
a memory having a phone number processing program for detecting a sequence of consecutive digits included in the received text message, determining whether the sequence of consecutive digits is a phone number, detecting when the user places the selection bar on the phone number and presses a call key or a phonebook key provided on the key input unit, dialing the phone number when a call key input signal is received, and storing the phone number when a phonebook key input signal is received; and
a microprocessor for controlling the mobile communication terminal to process data transmission or reception according to a defined communication protocol, and implementing the phone number processing program stored in the memory so as to perform a function to dial or store the phone number included in the text message.

7. The mobile communication terminal according to claim 6, wherein said microprocessor dials the phone number included in the phone number selection signal when a call menu input signal is received according to the user's selection of the call menu or the phonebook storage menu, and stores the phone number in the phonebook when a phonebook menu input signal is received.

8. The mobile communication terminal according to claim 6, wherein said microprocessor implements the phone number processing program upon receiving the text message in order to create a hyperlink on the phone number included in the text message and to allow the user to move and place the selection bar on the hyperlinked phone number.

9. The mobile communication terminal according to claim 6, wherein said microprocessor outputs a user interface screen displaying the text message with the hyperlinked phone number and the call menu and phonebook storage menu linked to the text message when the phone number selection signal is generated with the selection of the hyperlinked phone number.

10. The mobile communication terminal according to claim 6, wherein said microprocessor displays a menu containing one or more function modes if a menu key input signal is received while the selection bar is placed on the phone number in the text message, and implements a selected function mode.

11. The mobile communication terminal according to claim 10, wherein said function modes include save, call and message sending modes.
